(19) United States
(12) Patent Application Publication
(10) Pub. No.: US 2025/0043391 A1
(43) Pub. Date: Feb. 6, 2025

(54) METHOD FOR RECOVERING LITHIUM FROM LITHIUM-SALT-CONTAINING AQUEOUS SOLUTION

(71) Applicant: ASAKA RIKEN CO., LTD., KORIYAMA-SHI, FUKUSHIMA (JP)

(72) Inventors: Keita YAMADA, KORIYAMA-SHI, FUKUSHIMA (JP); Yukio SAKUMA, KORIYAMA-SHI, FUKUSHIMA (JP); Taro HIRAOKA, KORIYAMA-SHI, FUKUSHIMA (JP); Hiroto INOUE, KORIYAMA-SHI, FUKUSHIMA (JP)

(21) Appl. No.: 18/723,572

(22) PCT Filed: Dec. 28, 2022
(86) PCT No.: PCT/JP2022/048492

§ 371 Date: Jun. 24, 2024

(30) Foreign Application Priority Data
Jan. 21, 2022 (JP) 2022-008265
Jan. 28, 2022 (JP) 2022-012433

(51) Int. Cl. C22B 26/12; C22B 3/20; H01M 10/54

(52) U.S. Cl. CPC C22B 26/12; C22B 3/20; H01M 10/54

(57) ABSTRACT

Provided is a method for recovering lithium from lithium-salt-containing aqueous solution by using small-scale equipment in a short time. The method for recovering lithium from lithium-salt-containing aqueous solution includes an aluminum hydroxide producing step of producing aluminum hydroxide in the aqueous liquid containing a lithium salt. In one embodiment of this lithium recovery method, aluminum phosphate is removed from a first slurry containing a mixture of lithium phosphate obtained from a first aqueous lithium salt solution and aluminum hydroxide to provide a second aqueous lithium salt solution, a second slurry obtained by adding an aluminum salt to the second aqueous lithium salt solution is adjusted to a specific condition, and a precipitate of aluminum phosphate is filtered off and removed from the second aqueous lithium salt solution to provide a high-purity aqueous lithium salt solution.

### TECHNICAL FIELD

The present invention relates to a method for recovering lithium from aqueous liquid containing a lithium salt.

### BACKGROUND ART

In recent years, lithium has attracted attention as a raw material for lithium-ion batteries such as lithium-ion secondary batteries, and its supply sources include minerals, salt water, seawater, and the like, in addition to those recycled from waste lithium batteries. The salt water is obtained from natural salt lakes and contains lithium, typically in the form of lithium chloride. The concentration of lithium contained in the salt water is about 1 g/L.

Therefore, the salt water obtained from a natural salt lake is supplied to an open-field evaporation pond, concentration is performed by natural evaporation over one year or more, impurities such as Mg, Ca, and B are removed, and lithium carbonate is then precipitated to be recovered. However, in the method for concentrating the salt water by natural evaporation, it takes a long time to concentrate the salt water, the method is easily affected by natural conditions such as weather, lithium is lost by formation of a salt with other impurities during the concentration process, and the solubility of lithium sulfate in water is low, and lithium in the salt water precipitates as lithium sulfate when the sulfate is dissolved in the salt water. Thus, the method is a problematic in that lithium cannot be completely recovered from the salt water.

Meanwhile, there is known a method in which phosphorus, phosphoric acid, or a phosphate is added to the salt water to generate and concentrate lithium phosphate, as a method for recovering lithium carbonate from the salt water (refer to, for example, Patent Literature 1).

The method described in Patent Literature 1 is a method of adding an aluminum salt to the lithium phosphate to prepare a slurry containing the lithium phosphate and the aluminum salt, adjusting the pH of the slurry to a range of 3.8 to 4.6 to precipitate phosphate ions (PO₄³⁻) and aluminum ions (Al³⁺) contained in the slurry as aluminum phosphate (AlPO₄), and then filtering off and removing the aluminum phosphate (AlPO₄) to obtain a crude aqueous lithium salt solution. Chinese Patent Publication No. 108675323 describes that the crude aqueous lithium salt solution can be further purified by treatments such as pH adjustment and the use of an ion exchange membrane to remove impurities, thereby providing a high-purity aqueous lithium salt solution, and a carbonate such as sodium carbonate is added to the high-purity aqueous lithium salt solution to provide lithium carbonate.

In addition, Patent Literature 1 describes four types of compounds of aluminum chloride, aluminum sulfate, potassium aluminum sulfate, and aluminum nitrate as the aluminum salt.

### CITATION LIST

### Patent Literature

Patent Literature 1: Chinese Patent Publication No. 108675323

### SUMMARY OF INVENTION

### Technical Problem

The method described in Patent Literature 1 is problematic in that the aluminum phosphate (AlPO₄, precipitated by adjusting the pH of a slurry containing lithium phosphate and aluminum salt, has a low filterability, it takes a long time for an operation of filtering off the aluminum phosphate, and the large-scale equipment to perform the method is needed.

In recent years, there has been a demand for a method for recovering lithium from an aqueous liquid in which a lithium salt is dissolved by using small-scale equipment in a short time, but such a method has not been provided. The problem to be solved by the present invention is to provide a method for recovering lithium from an aqueous liquid in which a lithium salt is dissolved by using small-scale equipment in a short time.

### Solution to Problem

The present inventors have repeatedly investigated in view of the above problem and found that the problem can be solved by the method for recovering lithium from an aqueous liquid containing a lithium salt, the method including a step of producing aluminum hydroxide in an aqueous liquid containing a lithium salt. The present invention has been completed based on the above finding.

The present invention relates to a method for recovering lithium from an aqueous liquid containing a lithium salt, the method including an aluminum hydroxide-producing step of producing aluminum hydroxide in an aqueous liquid containing a lithium salt.

A method for recovering lithium from an aqueous liquid containing a lithium salt according to the present invention preferably includes: a phosphorylation step of adding an aqueous solution of aluminum phosphate and an alkali metal hydroxide to an aqueous liquid containing a lithium salt to produce a solid containing lithium phosphate and aluminum hydroxide; a first solid-liquid separation step for separating the solid; a pH adjustment step of adding a mineral acid to a suspension obtained by suspending the solid separated in the first solid-liquid separation step in water to adjust the pH of the suspension to 2 to 3; and a second solid-liquid separation step of solid-liquid separation of the aluminum phosphate-lithium salt aqueous solution obtained in the pH adjustment step; and a lithium separation step of separating lithium as at least one selected from the group consisting of lithium carbonate and lithium hydroxide from the aqueous lithium salt solution obtained in the second solid-liquid separation step, wherein the aluminum phosphate obtained in the second solid-liquid separation step is reused in the phosphorylation step. In the method for recovering lithium from an aqueous liquid containing a lithium salt according to the present invention, the aluminum phosphate-lithium salt aqueous solution obtained in the pH adjustment step can be rapidly subjected to solid-liquid separation. Therefore, there is provided a method for recovering a large amount of lithium from an aqueous liquid in which a lithium salt is dissolved by using small-scale equipment in a short time.

The lithium separation step preferably includes a carbonation step of carbonating the aqueous lithium salt solution obtained in the second solid-liquid separation step to provide lithium carbonate.

In addition, the lithium separation step preferably includes a membrane electrolysis step of membrane electrolysis of an aqueous lithium salt solution obtained in the second solid-liquid separation step with an ion exchange membrane to provide a lithium hydroxide aqueous solution.

Renewable energy is preferably used as the power used in the membrane electrolysis step.

At least one selected from the group consisting of solar power generation and wind power generation is more preferably used as the power used in the membrane electrolysis step.

The mineral acid used in the pH adjustment step preferably contains at least one selected from the group consisting of hydrochloric acid, sulfuric acid, and nitric acid.

The method for recovering lithium from an aqueous liquid containing a lithium salt according to the present invention preferably includes: a step of adjusting the pH of a first slurry containing a mixture of lithium phosphate obtained from the first aqueous lithium salt solution, as a raw material, containing a lithium salt in the range of 0.1 to 70 g/L in terms of lithium, and aluminum hydroxide to the range of 2 to 3 to provide a precipitate of aluminum phosphate; a step of filtering off and removing the precipitate of aluminum phosphate from the first slurry containing the mixture of lithium phosphate and aluminum hydroxide to provide a second aqueous lithium salt solution; and a step of filtering off and removing a precipitate of aluminum phosphate from the second slurry obtained by adding an aluminum salt to the second aqueous lithium salt solution to provide a high-purity aqueous lithium salt solution, wherein the second slurry is prepared so as to satisfy the following condition (1) or (2):

4.5pH of the second slurry≤7 Condition (1)

7<pH of the second slurry≤8 and Al/P≥3 Condition (2)
wherein Al indicates the mass of aluminum as an element in the compound contained in the second slurry, and P indicates the mass of phosphorus as an element in the compound contained in the second slurry.

Preferably, an aluminum salt and phosphoric acid are added to the first aqueous lithium salt solution and the pH is adjusted to a range of 8 to 14 to provide the mixture of lithium phosphate and aluminum hydroxide.

More preferably, the precipitate of aluminum phosphate filtered off from at least one selected from the group consisting of the first slurry and the second slurry is added to at least one selected from the group consisting of the first aqueous lithium salt solution and the second aqueous lithium salt solution.

Before adjusting the pH of the first slurry containing the mixture of lithium phosphate obtained from the first aqueous lithium salt solution and aluminum hydroxide to a range of 2 to 3, the mixture of lithium phosphate and aluminum hydroxide is preferably filtered off from the first slurry containing the mixture of lithium phosphate and aluminum hydroxide, and the filtered-off mixture of lithium phosphate and aluminum hydroxide is dispersed in a smaller amount of water than the first aqueous lithium salt solution to provide a first slurry containing a mixture of concentrated lithium phosphate and aluminum hydroxide.

More preferably, the method for recovering lithium from an aqueous liquid containing a lithium salt according to the present invention further includes a step of producing aluminum phosphate from the second slurry at 50° C. or less.

### BRIEF DESCRIPTION OF DRAWINGS

FIG. 1 is an explanatory view showing one embodiment of the method for recovering lithium from an aqueous liquid containing a lithium salt according to the present invention;

FIG. 2 is an explanatory view showing one embodiment of a lithium separation step of the method for recovering lithium from an aqueous liquid containing a lithium salt according to the present invention;

FIG. 3 is an explanatory cross-sectional view showing the structure of an ion-exchange membrane electrolysis cell used in the method for recovering lithium from an aqueous liquid containing a lithium salt according to the present invention; and

FIG. 4 is a flow chart showing another embodiment of the method for recovering lithium from an aqueous liquid containing a lithium salt according to the present invention.

### DESCRIPTION OF EMBODIMENTS

The method for recovering lithium from an aqueous liquid containing a lithium salt according to the present invention (hereinafter sometimes referred to as the recovery method of the present invention) includes an aluminum hydroxide producing step of producing aluminum hydroxide in the aqueous liquid containing a lithium salt.

One embodiment of the present invention will be described in detail with reference to the accompanying drawings.

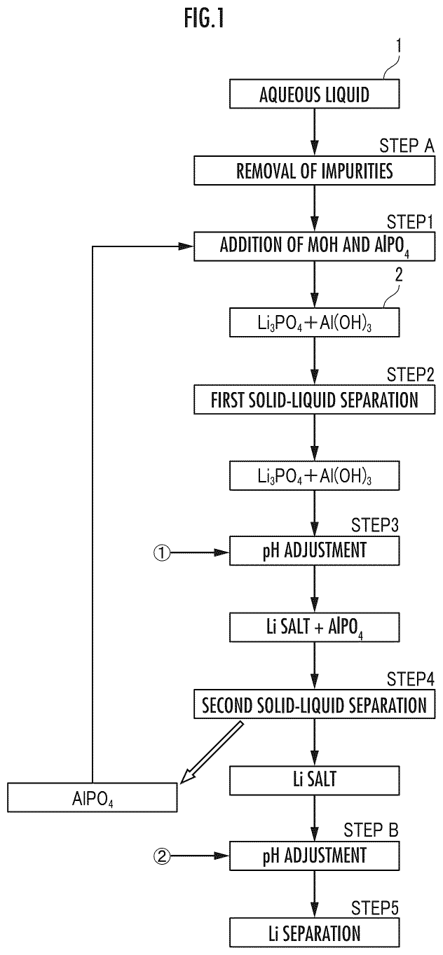

As shown in FIG. 1, one embodiment of the recovery method of the present invention (hereinafter sometimes referred to as embodiment 1) uses an aqueous liquid 1 containing, for example, a lithium salt as a starting material. The aqueous liquid 1 is a liquid in which water accounts for 50% by mass or more, preferably 70% by mass or more, more preferably 80% by mass or more, and still more preferably 100% by mass of the solvent. Examples of the aqueous liquid 1 include an aqueous solution, a water dispersion, and a water emulsion. The preferable aqueous liquid 1 is an aqueous solution in which a lithium salt is dissolved, the more preferable aqueous liquid 1 is brine derived from at least one selected from the group consisting of salt lakes, seawater, and brackish water, and the more preferable aqueous liquid 1 is brine derived from a salt lake.

### <Impurity Removal Step>

When the aqueous liquid 1 contains at least one selected from the group consisting of calcium, magnesium, and boron, such as brine from a salt lake, the embodiment 1 may include an impurity removal step (STEP A) to remove these metals.

The impurity removal step is not limited to a specific method. One embodiment of the impurity removal step is as follows.

When the aqueous liquid 1 contains at least one selected from the group consisting of calcium, magnesium, and boron, these may be removed from the aqueous liquid 1 by the method disclosed in Japanese Patent No. 6122944, for example. That is, magnesium can be produced as magnesium hydroxide by mixing at least one selected from the group consisting of alkali metal hydroxides and aqueous solutions thereof with the aqueous liquid 1. In this case, the pH of the salt water mixed with the alkali metal hydroxide is maintained at 8.5 to 10.5, and boron (for example, boron ion) is adsorbed on the magnesium hydroxide, thereby allowing magnesium and boron to be co-precipitated. In order to separate magnesium hydroxide precipitated by boron adsorption and salt water, magnesium and boron are simultaneously recovered by solid-liquid separation such as filtration, and a filtrate is obtained. An alkali metal hydroxide or alkali metal carbonate (for example, NaOH or carbonate singly or in combination) may be mixed with the filtrate and the pH of the filtrate is maintained at 12 or more, thereby allowing calcium to be precipitated. Calcium is removed from the aqueous liquid 1 by precipitating calcium hydroxide or calcium carbonate depending on the type of the alkali metal hydroxide or alkali metal carbonate mixed with the filtrate.

The alkali metal of the alkali metal hydroxide contains at least one selected from the group consisting of sodium, potassium, rubidium, cesium, and francium. The alkali metal preferably contains at least one selected from the group consisting of sodium and potassium, more preferably sodium or potassium, and still more preferably sodium.

### <Phosphorylation Step>

The embodiment 1 includes a phosphorylation step (STEP 1) of adding aluminum phosphate and an alkali metal hydroxide (MOH) aqueous solution to the aqueous liquid from which at least one selected from the group consisting of calcium, magnesium, and boron has been removed as necessary to produce a solid 2 containing lithium phosphate and aluminum hydroxide. Alkali metal salts such as alkali metal chloride (MCl) and alkali metal sulfate (M₂SO₄) are dissolved in the aqueous liquid in which the solid 2 (lithium phosphate and aluminum hydroxide) has been produced.

The alkali metal of the alkali metal hydroxide contains at least one selected from the group consisting of sodium, potassium, rubidium, cesium, and francium. The alkali metal is preferably at least one selected from the group consisting of sodium and potassium, more preferably sodium.

### <First Solid-Liquid Separation Step>

The embodiment 1 includes a first solid-liquid separation step (STEP 2) of solid-liquid separation of the solid 2 produced in the phosphorylation step. Examples of the first solid-liquid separation step include filtration.

### <pH Adjustment Step>

In the embodiment 1, the solid 2 separated in the first solid-liquid separation step may be washed. The embodiment 1 includes a pH adjustment step (STEP 3) in which a mineral acid is added to the suspension obtained by suspending the solid 2 in water to adjust the pH of the suspension to 2 to 3. The mineral acid preferably contains at least one selected from the group consisting of hydrochloric acid, sulfuric acid, and nitric acid, is more preferably at least one selected from the group consisting of hydrochloric acid, sulfuric acid, and nitric acid, is more preferably hydrochloric acid, sulfuric acid, or nitric acid, and is particularly preferably hydrochloric acid. An aqueous solution of a lithium salt such as lithium chloride in which aluminum phosphate is dispersed is obtained in the pH adjustment step.

### <Second Solid-Liquid Separation Step>

The embodiment 1 includes a second solid-liquid separation step (STEP 4) of solid-liquid separation of the aluminum phosphate-lithium salt aqueous solution obtained in the pH adjustment step. Examples of the second solid-liquid separation step include filtration. The aluminum phosphate obtained in the second solid-liquid separation step contains a trace amount of aluminum hydroxide that has not reacted in the pH adjustment step, and can be solid-liquid separated in a short time, and the solid-liquid separated aluminum phosphate is reused in the phosphorylation step.

The embodiment 1 may include a second pH adjustment step (STEP B) of adding alkali metal hydroxide (M¹OH) aqueous solution preferably in the second pH adjustment step to the aqueous lithium salt solution obtained by separating aluminum phosphate in the second solid-liquid separation step to adjust the pH of the aqueous lithium salt solution. The pH of the aqueous lithium salt solution is preferably adjusted to the range of 4.5 to 8, more preferably 5 to 7. The alkali metal of the alkali metal hydroxide contains at least one selected from the group consisting of lithium, sodium, potassium, rubidium, cesium, and francium. The alkali metal is preferably at least one selected from the group consisting of sodium and potassium, more preferably lithium or sodium.

### <Lithium Separation Step>

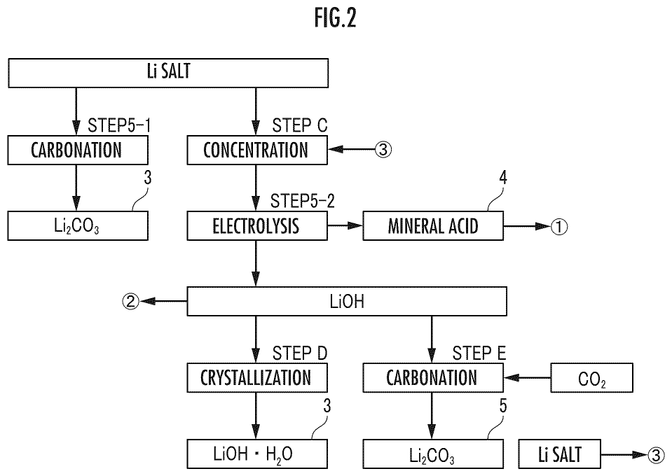

The embodiment 1 includes a lithium separation step (STEP 5) of separating lithium as at least one selected from the group consisting of lithium carbonate and lithium hydroxide from the aqueous lithium salt solution, the pH of which is adjusted as necessary, obtained in the second solid-liquid separation step. One embodiment of the lithium separation step is shown in FIG. 2.

### <Carbonation Step>

The lithium separation step is not limited to a specified method. The lithium separation step preferably includes a carbonation step (STEP 5-1) of carbonating the aqueous lithium salt solution obtained in the second solid-liquid separation step to provide lithium carbonate 3. In the carbonation step, an alkali metal carbonate (excluding lithium carbonate) is added to the aqueous lithium salt solution.

The alkali metal of the alkali metal carbonate is at least one selected from the group consisting of sodium, potassium, rubidium, cesium, and francium. The alkali metal is preferably at least one selected from the group consisting of sodium and potassium, more preferably sodium.

### <Membrane Electrolysis Step>

The lithium separation step may include a concentration step (STEP C) of concentrating the aqueous lithium salt solution obtained in the second solid-liquid separation step and optionally subjected to the second pH adjustment step (STEP B). The concentration step can be performed by using, for example, a reverse osmosis membrane (RO membrane).

In addition, the lithium separation step may include a membrane electrolysis step (STEP 5-2) of membrane electrolysis of, with an ion exchange membrane, the aqueous lithium salt solution obtained in the second solid-liquid separation step and optionally subjected to at least one selected from the group consisting of the second pH adjustment step (STEP B) and the concentration step (STEP C) to provide lithium hydroxide aqueous solution.

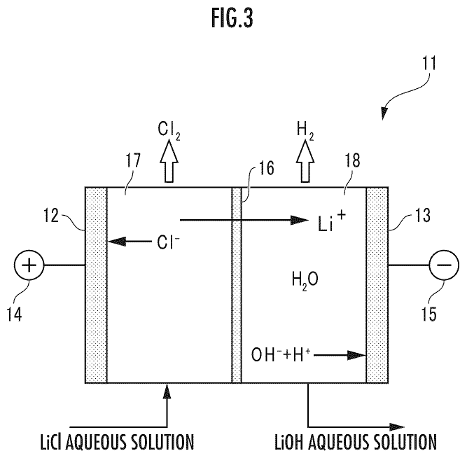

The membrane electrolysis step can be performed by, for example, using a membrane electrolysis cell 11 shown in FIG. 3.

The membrane electrolysis cell 11 comprises a positive electrode plate 12 on one inner surface and a negative electrode plate 13 on the inner surface facing the positive electrode plate 12. The positive electrode plate 12 is connected to a positive electrode 14 of the power supply and the negative electrode plate 13 is connected to a negative electrode 15 of the power supply. In addition, the membrane electrolysis cell 11 is partitioned by an ion exchange membrane 16 into a positive electrode chamber 17 comprising the positive electrode plate 12 and a negative electrode chamber 18 comprising the negative electrode plate 13.

In the membrane electrolysis cell 11, when the aqueous lithium salt solution is supplied to the positive electrode chamber 17 to perform membrane electrolysis, chloride ions form chlorine gas (Cl₂) on the positive electrode plate 12. On the other hand, alkali metal ions such as lithium ions move to the negative electrode chamber 18 through the ion exchange membrane 16. FIG. 3 shows membrane electrolysis of the aqueous lithium salt solution in which lithium chloride is dissolved.

In the negative electrode chamber 18, water (H₂O) is ionized into hydroxide ions (OH⁻) and hydrogen ions (H⁺), and the hydrogen ions form hydrogen gas (H₂) on the negative electrode plate 13. On the other hand, an alkali metal hydroxide aqueous solution such as lithium hydroxide is produced from hydroxide ions and alkali metal ions such as lithium ions. The alkali metal hydroxide aqueous solution may be used in the second pH adjustment step (STEP B).

For example, renewable energy, preferably at least one selected from the group consisting of solar power generation and wind power generation, is used as the power required for the membrane electrolysis step.

Hydrogen gas (H₂) and chlorine gas (Cl₂) generated in the membrane electrolysis step are reacted to provide hydrochloric acid. Although not shown in FIG. 3, sulfuric acid can be obtained in the positive electrode chamber 17 when the aqueous lithium salt solution contains sulfate ions. When the aqueous lithium salt solution contains nitrate ions, nitric acid can be obtained in the positive electrode chamber 17. That is, the mineral acid 4 can be obtained in the membrane electrolysis step, and the mineral acid 4 may be used in the pH adjustment step (STEP 3).

### (Separation of Lithium Hydroxide Monohydrate)

The lithium separation step may include a crystallization step (STEP D) of evaporating and concentrating the alkali metal hydroxide aqueous solution obtained in the membrane electrolysis step to crystallize lithium hydroxide monohydrate 5.

### <Separation of Lithium Carbonate>

The lithium separation step may include a second carbonation step (STEP E) of blowing carbon dioxide into the lithium hydroxide aqueous solution obtained in the membrane electrolysis step to generate lithium carbonate 6. The aqueous lithium salt solution obtained by subjecting the slurry obtained in the second carbonation step to solid-liquid separation such as filtration may be concentrated in the concentration step (STEP C).

Then, another embodiment of the present invention (hereinafter sometimes referred to as embodiment 2) will be described in detail with reference to the accompanying drawings.

### <Step of Obtaining Precipitate of Aluminum Phosphate>

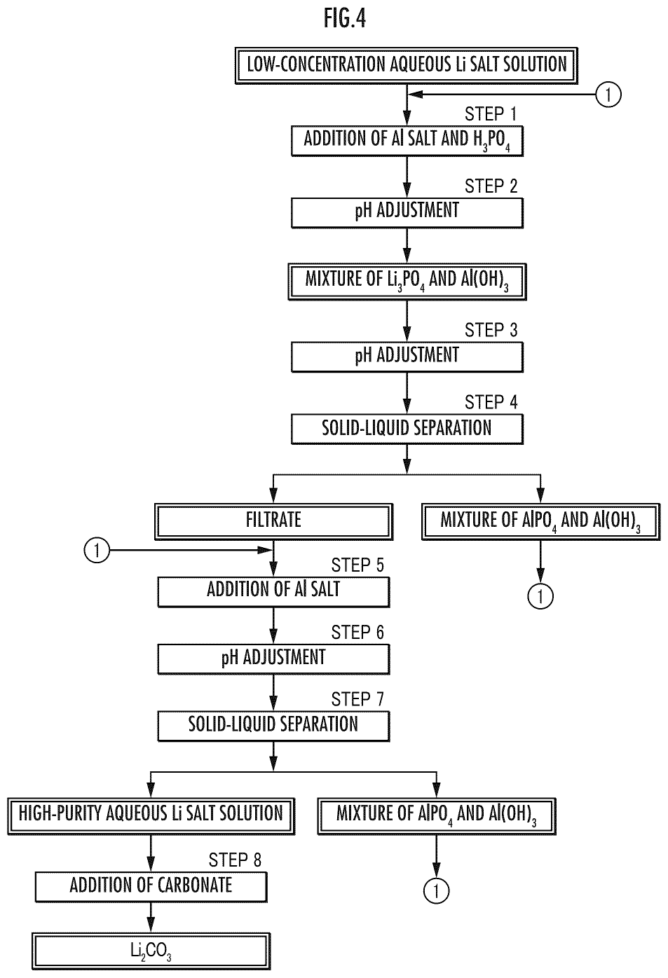

As shown in FIG. 4, in the method for recovering lithium from an aqueous liquid containing a lithium salt in the embodiment 2, first, in STEP 1 of FIG. 4, an aluminum (Al) salt and phosphoric acid (H₃PO₄) are added to a low-concentration aqueous lithium (Li) salt solution as the first aqueous lithium salt solution. The low-concentration aqueous Li salt solution includes a lithium salt such as lithium chloride in a range of 0.1 to 70 g/L in terms of lithium. Examples of such a usable low-concentration aqueous Li salt solution include a natural salt water obtained from a salt lake, seawater, or brackish water, and a low-concentration aqueous lithium salt solution obtained from a waste lithium ion battery recovery process. The Al salt added to the low-concentration aqueous Li salt solution may be any Al salt. The Al salt contains at least one selected from the group consisting of aluminum chloride, aluminum sulfate, and aluminum nitrate, more preferably at least one selected from the group consisting of aluminum chloride, aluminum sulfate, and aluminum nitrate, more preferably aluminum chloride, aluminum sulfate, or aluminum nitrate, and particularly preferably aluminum chloride.

Then, in STEP 2, the pH of the low-concentration aqueous Li salt solution to which Al salt and H₃PO₄ are added may be adjusted to a range of 8 to 14, preferably a range of 10 to 11. The pH adjustment in STEP 2 can be performed by, for example, adding at least one selected from the group consisting of an alkali metal hydroxide and an aqueous solution thereof to the low-concentration aqueous Li salt solution to which Al salt and H₃PO₄ have been added. The alkali metal of the alkali metal hydroxide is at least one selected from the group consisting of sodium, potassium, rubidium, cesium, and francium. The alkali metal is preferably at least one selected from the group consisting of sodium and potassium, more preferably sodium.

This manner generates lithium phosphate (Li₃PO₄) and aluminum hydroxide (Al(OH)₃) in the low-concentration aqueous Li salt solution to which Al salt and H₃PO₄ have been added, thereby allowing to obtain a first slurry containing the mixture of Li₃PO₄ and Al(OH)₃.

Then, in STEP 3, the pH of the first slurry is adjusted to a range of 2 to 3. The pH adjustment in STEP 2 can be performed by adding, for example, hydrochloric acid or sulfuric acid. In this way, aluminum phosphate (AlPO₄) is generated from Li₃PO₄ and Al(OH)₃ and precipitates.

### <Step of Obtaining Second Aqueous Lithium Salt Solution>

Then, in STEP 4, the AlPO₄ is filtered off and removed for the first solid-liquid separation from the first slurry, thereby allowing providing a filtrate as the second aqueous lithium salt solution. In this case, the AlPO₄ is generated from the first slurry and thus includes a trace amount of unreacted Al(OH)₃. As a result, it is considered that the filterability of the AlPO₄ is improved, and the filtering-off operation can be performed in a short time.

In the embodiment 2, the first slurry containing the mixture of Li₃PO₄ and Al(OH)₃ obtained in STEP 2 may be concentrated by filtering off Li₃PO₄ and Al(OH)₃ for solid-liquid separation and redispersing in a smaller amount of water than the low-concentration aqueous Li salt solution before adjusting the pH of the first slurry to the range of 2 to 3 in STEP 3. Concentrating the first slurry allows the operation of filtering off the AlPO₄ from the first slurry in STEP 4 in a shorter time.

The filtrate obtained in STEP 4 is a lithium chloride aqueous solution when the pH is adjusted by adding hydrochloric acid in STEP 3, and is a lithium sulfate aqueous solution when the pH is adjusted by adding sulfuric acid in STEP 3. In addition, the AlPO₄ containing a trace amount of Al(OH)₃ separated in STEP 4 (mixture of AlPO₄ and Al(OH)₃) can be returned to STEP 1.

### <Step of Obtaining High-Purity Aqueous Lithium Salt Solution>

Then, in STEP 5, an Al salt is added to the filtrate obtained in STEP 4 to provide a second slurry. The Al salt added to the filtrate in STEP 5 may be any Al salt, similar to the Al salt added in STEP 1.

The mass of the Al salt added in STEP 5 is adjusted according to the pH of the second slurry adjusted in STEP 6 described below.

(Amount of Al Salt Added when 4.5≤pH of Second Slurry≤7)

When the following condition (1) is satisfied, the mass of the Al salt added in STEP 5 is adjusted so that the following Al/P is preferably 1 to 5, more preferably 2 to 4, and still more preferably 2 to 3.

4.5pH of the second slurry≤7 Condition (1)

When the Al salt added in STEP 5 is within the above range, the concentration of impurities (phosphorus and aluminum) in the aqueous lithium salt solution obtained in the second solid-liquid separation in STEP 7 described later is decreased, the amount of AlPO₄ generated in the second slurry becomes appropriate, and the second solid-liquid separation in STEP 7, which will be described later, is efficiently performed.

(Amount of Al Salt Added when 7<pH of Second Slurry≤8)

In addition, the mass of the Al salt added in STEP 5 is adjusted so that the following condition (2) is satisfied.

7<pH of the second slurry≤8 and AU/P≥3 Condition (2),
wherein Al indicates the mass of aluminum as an element in the compound contained in the second slurry, and P indicates the mass of phosphorus as an element in the compound contained in the second slurry.

When the amount of the Al salt added in STEP 5 is too small, AlPO₄ is not stably generated in the second slurry, and the concentration of phosphorus in the aqueous lithium salt solution obtained in the second solid-liquid separation in STEP 7, which will be described later, becomes too high. In addition, when the amount of Al added in STEP 5 is too large, a large amount of AlPO₄ and Al(OH)₃ is produced in the second slurry, and the second solid-liquid separation in STEP 7, which will be described later, becomes inefficient.

Thereafter, in STEP 6, the pH of the Al salt-added filtrate is adjusted to a range of 4.5 to 8 by adding, for example, at least one of an alkali metal hydroxide and the aqueous solution thereof. The alkali metal hydroxide is the same as the alkali metal hydroxide used in STEP 2. The Al salt reacts with the phosphate dissolved in the filtrate to stably produce AlPO₄.

The above reaction is preferably performed at 50° C. or less. Therefore, the slurry obtained by adding an Al salt to the filtrate in STEP 6 contains AlPO₄ and Al(OH)₃. Furthermore, phosphorus in the slurry is adsorbed on the Al(OH)₃.

Then, in STEP 7, AlPO₄ and Al(OH)₃ having phosphorus adsorbed are filtered off and removed from the second slurry through the second solid-liquid separation, thereby allowing to provide a high-purity aqueous lithium salt solution in which the concentrations of phosphorus and aluminum as impurities are reduced. The concentrations of phosphorus and Al in the high-purity aqueous lithium salt solution are 1 mg/L or less and 0.1 mg/L or less, respectively. In STEP 7, the filtered-off mixture of AlPO₄ and a trace amount of Al(OH)₃ contains lithium, and therefore can be returned to at least one of STEP 1 and STEP 5. As a result, the recovery rate of lithium can be improved.

Lithium carbonate can be obtained by adding an alkali metal carbonate such as sodium carbonate in STEP 8 to the high-purity aqueous lithium salt solution obtained in the embodiment 2. The alkali metal of the alkali metal carbonate is at least one selected from the group consisting of sodium, potassium, rubidium, cesium, and francium. The alkali metal is preferably at least one selected from the group consisting of sodium and potassium, more preferably sodium or potassium, and still more preferably sodium.

### EXAMPLES

The present invention will be described in more detail below based on Examples, but the present invention is not limited to these.

In Examples and Comparative Examples, various physical properties were measured as follows.

### <Content of Ions in Aqueous Solutions of Examples 1 and 2>

The content of ions in the aqueous solutions of Examples 1 and 2 was measured by ion chromatograph (IC) manufactured by Metrohm AG.

### <Content of Impurities in Lithium Carbonate>

The content of impurities in lithium carbonate was measured by an inductively coupled plasma-optical emission spectrometer (ICP-OES), Optima8300 manufactured by PerkinElmer Inc.

### <Measurement of Concentration of Each Element in Aqueous Solutions of Examples 3 to 6 and Reference Examples 1 to 4>

The concentration of each element in the aqueous solutions of Examples 3 to 6 and Reference Examples 1 to 4 was measured by an inductively coupled plasma-optical emission spectrometer (ICP-OES), Optima8300 manufactured by PerkinElmer Inc.

### Example 1

Aluminum phosphate of 450 g was dissolved in 100 kg of an aqueous solution containing 0.70 g of Li, 5.45 g of K, 100.52 g of Na, 151.61 g of Cl, and 20.88 g of SO₄ per 1 kg of the simulated solution of brine from salt lakes, sodium hydroxide was added to adjust the pH of the aqueous solution to 10.5, and the reaction was performed to provide a white slurry A. Then, the white slurry A was filtered and washed to provide 1380 g of a white cake A having a moisture content of 55%. The white cake A was suspended in 750 mL of pure water, and 35% by mass of hydrochloric acid was added to adjust the pH of the suspension to 2.5. The suspension was heated to 60° C. and reacted to provide a white slurry B. The white slurry B was filtered and washed to provide 1126 g of a white cake B having a moisture content of 60%, a filtrate, and wash liquid. The filtrate and wash liquid were adjusted to pH 7 with lithium hydroxide and then filtered to provide 3850 mL of a lithium salt solution. An aqueous solution prepared by dissolving 500 g of sodium carbonate in 940 ml of water was added to the lithium salt solution (95.4 g/L of lithium chloride concentration) and heated to 60° C. for reaction. The resulting solid was filtered and washed to provide hydrous lithium carbonate. The hydrous lithium carbonate was dried at 500° C. to provide 257 g of lithium carbonate. The recovery rate of lithium was 69%. The content of sodium in the lithium carbonate was less than 200 ppm, the content of potassium was less than 10 ppm, the content of aluminum was less than 10 ppm, the content of phosphorus was less than 10 ppm, the content of chlorine was less than 50 ppm, the content of sulfate ions was less than 400 ppm in terms of SO₄, and the water content was less than 0.1% by mass.

### Example 2

Lithium chloride aqueous solution (200 g/L of lithium chloride concentration) obtained in the same manner as in Example 1 was subjected to membrane electrolysis by using an ion exchange membrane (Nafion N324 manufactured by The Chemours Company) under the conditions of a current density of 40 A/dm² and an electrode area of 0.7 dm² to provide 1670 g of 6.2% by mass of a lithium hydroxide aqueous solution. The current efficiency in the membrane electrolysis step was 83%.

The lithium hydroxide aqueous solution of 800 g with 6.2% by mass was taken, and 80% by mass of the aqueous solution was crystallized to provide 70 g (mass after drying) of lithium hydroxide monohydrate crystals. The content of sodium in the lithium hydroxide monohydrate was less than 20 ppm, the content of aluminum was less than 5 ppm, and the content of phosphorus was less than 5 ppm.

The lithium hydroxide aqueous solution of 800 g with 6.2% by mass was taken, carbon dioxide gas was blown thereto, warmed at 60° C. for 1 hour, filtered and washed to provide 68 g (mass after drying) of lithium carbonate. The content of sodium in the lithium carbonate was less than 50 ppm, the content of aluminum was less than 5 ppm, and the content of phosphorus was less than 5 ppm.

### Example 3

In the present Example, first, 27.5 g of lithium chloride was added to 1.5 L of ion-exchanged water to prepare a low-concentration aqueous lithium solution containing 3 g/L of lithium (Li) as the first aqueous lithium salt solution.

Then, in STEP 1 shown in FIG. 4, 54.8 g of aluminum chloride hexahydrate and 26.2 g of 85% by mass of phosphoric acid were added to the low-concentration aqueous lithium solution, and the liquid temperature was maintained at 60° C. and stirring was performed.

Then, in STEP 2 shown in FIG. 4, a sodium hydroxide aqueous solution was added to the low-concentration aqueous lithium solution to which aluminum chloride hexahydrate and phosphoric acid had been added, and stirring was performed to adjust the pH to 10. As a result, a slurry A containing a mixture of lithium phosphate (Li₃PO₄) and aluminum hydroxide (Al(OH)₃) was obtained.

Then, the slurry A was subjected to solid-liquid separation by filtration under reduced pressure. The filtered-off precipitate was washed with ion-exchanged water to obtain 281 g of a hydrous precipitate containing a mixture of lithium phosphate and aluminum hydroxide.

Then, 100 mL of an aqueous lithium solution containing 20 g/L of lithium was added to 131 g of the hydrous precipitate and redispersion was performed by stirring to obtain a concentrated slurry B containing a mixture of lithium phosphate and aluminum hydroxide.

Then, in STEP 3 shown in FIG. 4, the liquid temperature of the slurry B was maintained at 60° C., and hydrochloric acid was added to adjust the pH of the slurry B to 2.5. As a result, a slurry C containing a mixture of aluminum phosphate (AlPO₄) and aluminum hydroxide (Al(OH)₃) was obtained.

Then, in STEP 4 shown in FIG. 4, the slurry C was subjected to solid-liquid separation by filtration under reduced pressure. The filtered-off precipitate was washed with ion-exchanged water to obtain a hydrous precipitate containing a mixture of aluminum phosphate and aluminum hydroxide and a filtrate as the second aqueous lithium salt solution.

The filtrate contained 20 g/L of lithium, 100 mg/L of phosphorus, and 38 mg/L of aluminum (the above Al/P (mass ratio)=0.4). Aluminum chloride hexahydrate of 0.38 g was added to 0.5 L of the filtrate (STEP 5), and the pH of the second slurry obtained by adding 5% by mass of the sodium hydroxide aqueous solution was adjusted to 6.2 (STEP 6), and stirring was performed at 22° C. for about 1 hour to provide a slurry D having the above Al/P (mass ratio)=2.5. The slurry D was subjected to solid-liquid separation under the same conditions as in STEP 4 (STEP 7) to provide a high-purity aqueous lithium salt solution. Table 1 shows the concentrations of phosphorus and aluminum in the aqueous lithium salt solution.

### Example 4

A high-purity aqueous lithium salt solution was obtained by the same operation as in Example 3, except that the pH of the second slurry of Example 3 was set to 4.8 (the amount of 5% by mass of the sodium hydroxide aqueous solution added was changed) and the liquid temperature during stirring of the second slurry was set to 24° C. Table 1 shows the concentrations of phosphorus and aluminum in the aqueous lithium salt solution.

### Example 5

A high-purity aqueous lithium salt solution was obtained by the same operation as in Example 3, except that the pH of the second slurry of Example 3 was set to 6.7 (the amount of 5% by mass of the sodium hydroxide aqueous solution added was changed) and the liquid temperature during stirring of the second slurry was set to 24° C. Table 1 shows the concentrations of phosphorus and aluminum in the aqueous lithium salt solution.

### Example 6

A high-purity aqueous lithium salt solution was obtained by the same operation as in Example 3, except that the amount of aluminum chloride hexahydrate added to the second slurry of Example 3 was set to 0.83 g, the pH of the second slurry was set to 7.4 (the amount of 5% by mass of the sodium hydroxide aqueous solution added was changed), and the liquid temperature during stirring of the second slurry was set to 24° C. Table 1 shows the concentrations of phosphorus and aluminum in the aqueous lithium salt solution.

### Reference Example 1

An aqueous lithium salt solution was obtained by the same operation as in Example 3, except that aluminum chloride hexahydrate was not added to the slurry C of Example 3, and the pH of the second slurry of Example 3 was set to 6.6 (the amount of 5% by mass of the sodium hydroxide aqueous solution added was changed). Table 1 shows the concentrations of phosphorus and aluminum in the aqueous lithium salt solution.

### Reference Example 2

An aqueous lithium salt solution was obtained by the same operation as in Example 3, except that the pH of the second slurry of Example 3 was set to 4.3 (the amount of 5% by mass of the sodium hydroxide aqueous solution added was changed) and the liquid temperature during stirring of the second slurry was set to 24° C. Table 1 shows the concentrations of phosphorus and aluminum in the aqueous lithium salt solution.

### Reference Example 3

An aqueous lithium salt solution was obtained by the same operation as in Example 3, except that the pH of the second slurry of Example 3 was set to 7.4 (the amount of 5% by mass of the sodium hydroxide aqueous solution added was changed) and the liquid temperature during stirring of the second slurry was set to 24° C. Table 1 shows the concentrations of phosphorus and aluminum in the aqueous lithium salt solution.

### Reference Example 4

An aqueous lithium salt solution was obtained by the same operation as in Example 3, except that the pH of the second slurry of Example 3 was set to 8.4 (the amount of 5% by mass of the sodium hydroxide aqueous solution added was changed) and the liquid temperature during stirring of the second slurry was set to 24° C. Table 1 shows the concentrations of phosphorus and aluminum in the aqueous lithium salt solution.

TABLE 1

| | | | | | | Composition of aqueous Li | |
|---|---|---|---|---|---|---|---|
| | Treatment condition of second slurry | | | | | salt solution | |
| | | | | | Al/P | P | Al |
| | | Liquid | Reaction | Addition | mass | concentration | concentration |
| | pH | temperature | time | of Al salt | ratio | (mg/L) | (mg/L) |
| Example 3 | 6.2 | 22° C. | 1 hour | With | 2.5 | ≤1 | ≤0.1 |
| Example 4 | 4.8 | 24° C. | 1 hour | With | 2.5 | ≤1 | ≤0.1 |
| Example 5 | 6.7 | 24° C. | 1 hour | With | 2.5 | ≤1 | ≤0.1 |
| Example 6 | 7.4 | 24° C. | 1 hour | With | 5.0 | ≤1 | ≤0.1 |
| Reference | 6.6 | 22° C. | 1 hour | Without | 0.4 | 50 | ≤0.1 |
| Example 1 | | | | | | | |
| Reference | 4.3 | 24° C. | 1 hour | With | 2.5 | 20 | 50 |
| Example 2 | | | | | | | |
| Reference | 7.4 | 24° C. | 1 hour | With | 2.5 | 5 | ≤0.1 |
| Example 3 | | | | | | | |
| Reference | 8.4 | 24° C. | 1 hour | With | 2.5 | 15 | 1 |
| Example 4 | | | | | | | |

The aqueous lithium salt solution prepared in Reference Example 1, in which the second solid-liquid separation was performed without adding an Al salt to the second aqueous lithium salt solution, contained a large amount of phosphorus. The aqueous lithium salt solutions prepared in Reference Example 2, in which the pH of the second slurry was too low, and in Reference Example 4, in which the pH of the second slurry was too high, contained large amounts of phosphorus and aluminum. The aqueous lithium salt solution prepared in Reference Example 3, in which the Al/P ratio of the second slurry was less than 3 when the pH of the second slurry was 7<pH of the second slurry 8, contained a large amount of phosphorus. On the other hand, the aqueous lithium salt solutions prepared in Examples 3 to 6 contained only a small amount of phosphorus and aluminum, and the purity of the aqueous lithium salt solutions was very high.

From the above results, it was found that lithium can be recovered from an aqueous liquid in which a lithium salt was dissolved in a short time by using small-scale equipment.

### REFERENCE SIGNS LIST

1: Aqueous liquid, 2: Lithium phosphate and aluminum hydroxide, 3: Lithium carbonate, 4: Mineral acid, 5: Lithium hydroxide monohydrate, 6: Lithium carbonate, 11: Membrane electrolysis cell, 12: Positive electrode plate, 13: Negative electrode plate, 14: Positive electrode, 15: Negative electrode, 16: Ion exchange membrane, 17: Positive electrode chamber, 18: Negative electrode chamber.

1. A method for recovering lithium from aqueous liquid containing a lithium salt,
the method comprising an aluminum hydroxide producing step of producing aluminum hydroxide in an aqueous liquid containing the lithium salt.

2. The method for recovering lithium from an aqueous liquid containing a lithium salt according to claim 1, the method comprising:
a phosphorylation step of adding aluminum phosphate and an alkali metal hydroxide to an aqueous liquid containing a lithium salt to produce a solid containing lithium phosphate and aluminum hydroxide;
a first solid-liquid separation step of separating the solid;
a pH adjustment step of adding a mineral acid to a suspension obtained by suspending a solid separated in the first solid-liquid separation step in water to adjust pH of the suspension to 2 to 3;
a second solid-liquid separation step of solid-liquid separation of an aluminum phosphate-lithium salt aqueous solution obtained in the pH adjustment step; and
a lithium separation step of separating lithium as at least one selected from the group consisting of lithium carbonate and lithium hydroxide from an aqueous lithium salt solution obtained in the second solid-liquid separation step,
wherein aluminum phosphate obtained in the second solid-liquid separation step is reused in the phosphorylation step.

3. The method for recovering lithium from an aqueous liquid containing a lithium salt according to claim 2, wherein the lithium separation step comprises a carbonation step of carbonating an aqueous lithium salt solution obtained in the second solid-liquid separation step to provide lithium carbonate.

4. The method for recovering lithium from an aqueous liquid containing a lithium salt according to claim 2, wherein the lithium separation step comprises a membrane electrolysis step of membrane electrolysis of an aqueous lithium salt solution obtained in the second solid-liquid separation step with an ion-exchange membrane to provide a lithium hydroxide aqueous solution.

5. The method for recovering lithium from an aqueous liquid containing a lithium salt according to claim 4, wherein renewable energy is used as a power used in the membrane electrolysis step.

6. The method for recovering lithium from an aqueous liquid containing a lithium salt according to claim 5, wherein at least one selected from the group consisting of solar power generation and wind power generation is used as a power used in the membrane electrolysis step.

7. The method for recovering lithium from an aqueous liquid containing a lithium salt according to claim 2, wherein the mineral acid used in the pH adjustment step comprises at least one selected from the group consisting of hydrochloric acid, sulfuric acid, and nitric acid.

8. The method for recovering lithium from an aqueous liquid containing a lithium salt according to claim 1, the method comprising:
a step of adjusting pH of a first slurry including a mixture of lithium phosphate obtained from a first aqueous lithium salt solution, as a raw material, containing a lithium salt in a range of 0.1 to 70 g/L in terms of lithium, and aluminum hydroxide to a range of 2 to 3 to provide a precipitate of aluminum phosphate;
a step of filtering off and removing the precipitate of aluminum phosphate from a first slurry containing the mixture of lithium phosphate and aluminum hydroxide to provide a second aqueous lithium salt solution; and
a step of filtering off and removing a precipitate of aluminum phosphate from a second slurry obtained by adding an aluminum salt to the second aqueous lithium salt solution to provide a high-purity aqueous lithium salt solution,
wherein the second slurry is prepared so as to satisfy a following condition (1) or (2):
4.5≤pH of a second slurry≤7 condition (1)
7<pH of a second slurry≤8 and Al/P≥3 condition (2)
wherein Al indicates a mass of aluminum as an element in a compound contained in the second slurry, and P indicates a mass of phosphorus as an element in the compound contained in the second slurry.

9. The method for recovering lithium from an aqueous liquid containing a lithium salt according to claim 8, wherein an aluminum salt and phosphoric acid are added to the first aqueous lithium salt solution and the pH is adjusted to a range of 8 to 14 to provide the mixture of lithium phosphate and aluminum hydroxide.

10. The method for recovering lithium from an aqueous liquid containing a lithium salt according to claim 9, wherein the precipitate of aluminum phosphate filtered off from at least one selected from the group consisting of the first slurry and the second slurry is added to at least one selected from the group consisting of the first aqueous lithium salt solution and the second aqueous lithium salt solution.

11. The method for recovering lithium from an aqueous liquid containing a lithium salt according to claim 8, wherein before adjusting pH of the first slurry containing the mixture of lithium phosphate obtained from the first aqueous lithium salt solution and aluminum hydroxide to a range of 2 to 3, the mixture of lithium phosphate and aluminum hydroxide is filtered off from the first slurry containing the mixture of lithium phosphate and aluminum hydroxide, and the filtered-off mixture of lithium phosphate and aluminum hydroxide is dispersed in a smaller amount of water than the first aqueous lithium salt solution to provide a first slurry containing a mixture of concentrated lithium phosphate and aluminum hydroxide.

12. The method for recovering lithium from an aqueous liquid containing a lithium salt according to claim 8, the method comprising a step of producing aluminum phosphate from the second slurry at 50° C. or less.
